(19) United States
(12) Patent Application Publication
(10) Pub. No.: US 2009/0151849 A1
(43) Pub. Date: Jun. 18, 2009

(54) Cosmetic Wipe that Provides a Visual Indication of its Effectiveness

(75) Inventors: J. Gavin MacDonald, Decatur, GA (US); Molly K. Smith, Atlanta, GA (US); Aneshia D. Ridenhour, Canton, GA (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC., Neenah, WI (US)

(21) Appl. No.: 11/955,714

(22) Filed: Dec. 13, 2007

(51) Int. Cl. G01D 21/00; D04H 13/00

(52) U.S. Cl. 156/64; 442/330; 442/333

(57) ABSTRACT

A cosmetic wipe that contains a first nonwoven layer having first and second opposing surfaces is provided. The first nonwoven layer contains fibers formed from a polymer composition and is generally opaque in nature. A second nonwoven layer is laminated to the first surface of the first nonwoven layer. The second nonwoven layer contains a colorant that imparts a certain color to the second layer. Prior to use, the colored second layer is not generally visible when viewed from the second surface of the first layer due to the opaque nature of the first layer. However, sebum or other bodily oils absorbed by the first layer during use can prevent light from adequately reflecting from the layer. Thus, at least a portion of the first layer becomes translucent or transparent so that the color of the second layer becomes visible to a user. This provides a variety of benefits, including the ability for a user to evaluate if or how much sebum was removed from the skin so that makeup, etc. can be applied with confidence.

### BACKGROUND OF THE INVENTION

Sebaceous glands secrete an oily substance called sebum that is made of fat (lipids) and the debris of dead fat-producing cells. In the glands, sebum is produced within specialized cells and is released as these cells burst. To maintain cleanliness, reduce shine, and to improve the spreadability of cosmetics and other skin products, it is important to remove any excess surface oil or sebum. Although soap and water work to some extent, there are always situations in which a person is unable to wash his/her skin effectively. Dry methods of removing these facial oils have thus been developed that employ the use of thin oil absorbent paper wipes. One of the problems with such wipes, however, is that they do not significantly change appearance when they have absorbed oil or sebum. Thus, it is difficult for the user to ascertain if the wipe is functioning properly and whether cosmetics may be applied. Still other oil absorbent wipes have been developed that attempt to provide a visual indication to the user. U.S. Patent Application Publication No. 2003/0091618 to Seth, et al., for example, describes a wipe formed from an oil absorbing film-like substrate coated with an oil. The oil-coated areas enhance the ability of the film to change transparence or color upon the absorption of oil from a user's skin or hair. Such wipes, however, are overly complex and inefficient in that they require the addition of oil to the film for adequate functionality.

As such, a need currently exists for an improved cosmetic wipe that is capable of providing a user with a visual indication of its effectiveness.

### SUMMARY OF THE INVENTION

In accordance with one embodiment of the present invention, a cosmetic wipe is disclosed that comprises a first nonwoven layer and a second nonwoven layer laminated to the first nonwoven layer. The first nonwoven layer is generally opaque. The second nonwoven layer includes a colorant that provides the second layer with a color that is visually distinguishable from the color of the first nonwoven layer. At least a portion of the first nonwoven layer is configured to undergo a change in opacity upon the absorption of a bodily oil so that the portion is translucent or transparent to light, the color of the second nonwoven layer being visible through the translucent or transparent portion.

In accordance with another embodiment of the present invention, a method for assessing the effectiveness of a wipe in removing a bodily oil from the skin is disclosed. The method comprises providing a wipe that includes a first nonwoven layer and a second nonwoven layer laminated to the first nonwoven layer, the second nonwoven layer presenting a color that is visually distinguishable from the color presented by the first nonwoven layer. The skin is contacted with the first nonwoven layer of the wipe so that at least a portion of the first nonwoven layer undergoes a change in opacity and becomes translucent or transparent to light. The color of the second nonwoven layer is observed through the translucent or transparent portion of the first nonwoven layer.

Other features and aspects of the present invention are set forth in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 is a schematic illustration of one embodiment for forming a meltblown web for use in the cosmetic wipe of the present invention; and

FIG. 2 is a perspective view of one embodiment of the cosmetic wipe of the present invention.

### DETAILED DESCRIPTION OF REPRESENTATIVE EMBODIMENTS

Reference now will be made in detail to various embodiments of the invention, one or more examples of which are set forth below. Each example is provided by way of explanation, not limitation of the invention. In fact, it will be apparent to those skilled in the art that various modifications and variations may be made in the present invention without departing from the scope or spirit of the invention. For instance, features illustrated or described as part of one embodiment, may be used on another embodiment to yield a still further embodiment. Thus, it is intended that the present invention cover such modifications and variations.

Generally speaking, the present invention is directed to a cosmetic wipe that contains a first nonwoven layer having first and second opposing surfaces. The first nonwoven layer contains fibers formed from a polymer composition and is generally opaque in nature. A second nonwoven layer is laminated to the first surface of the first nonwoven layer. The second nonwoven layer contains a colorant that imparts a certain color to the second layer. Prior to use, the colored second layer is not generally visible when viewed from the second surface of the first layer due to the opaque nature of the first layer. However, sebum or other bodily oils absorbed by the first layer during use can prevent light from adequately reflecting from the layer. Thus, at least a portion of the first layer becomes translucent or transparent so that the color of the second layer becomes visible to a user. This provides a variety of benefits, including the ability for a user to evaluate if or how much sebum was removed from the skin so that makeup, etc. can be applied with confidence.

### I. First Nonwoven Layer

To optimize its oil adsorption capacity, the fibers of the first nonwoven layer are generally formed from a melt-extrudable polymer that is hydrophobic in nature. Examples of such polymers may include, for instance, polyolefins, such as polyethylene, such as high density polyethylene, medium density polyethylene, low density polyethylene, and linear low density polyethylene; polypropylene, such as isotactic polypropylene, atactic polypropylene, and syndiotactic polypropylene; polybutylene, such as poly(1-butene) and poly(2-butene); polypentene, such as poly(1-pentene) and poly(2-pentene); poly(3-methyl-1-pentene); poly(4-methyl-1-pentene); and copolymers and blends thereof. Suitable copolymers include random and block copolymers prepared from two or more different unsaturated olefin monomers, such as ethylene/propylene and ethylene/butylene copolymers. If desired, elastomeric polymers may also be used, such as elastomeric polyolefins, elastomeric copolymers, and so forth. Examples of elastomeric copolymers include block copolymers having the general formula A-B-A′ or A-B, wherein A and A′ are each a thermoplastic polymer endblock that contains a styrenic moiety and B is an elastomeric polymer midblock, such as a conjugated diene or a lower alkene polymer. Such copolymers may include, for instance, styrene-isoprene-styrene (S-I-S), styrene-butadiene-styrene (S-B-S), styrene-ethylene-butylene-styrene (S-EB-S), styrene-isoprene (S-I), styrene-butadiene (S-B), and so forth. Commercially available A-B-A′ and A-B-A-B copolymers include several different S-EB-S formulations from Kraton Polymers of Houston, Tex. under the trade designation KRATON®. KRATON® block copolymers are available in several different formulations, a number of which are identified in U.S. Pat. Nos. 4,663,220, 4,323,534, 4,834,738, 5,093,422 and 5,304,599, which are hereby incorporated in their entirety by reference thereto for all purposes. Other commercially available block copolymers include the S-EP-S elastomeric copolymers available from Kuraray Company, Ltd. of Okayama, Japan, under the trade designation SEPTON®. Still other suitable copolymers include the S-I-S and S-B-S elastomeric copolymers available from Dexco Polymers of Houston, Tex. under the trade designation VECTOR®. Also suitable are polymers composed of an A-B-A-B tetrablock copolymer, such as discussed in U.S. Pat. No. 5,332,613 to Taylor, et al., which is incorporated herein in its entirety by reference thereto for all purposes. An example of such a tetrablock copolymer is a styrene-poly(ethylene-propylene)-styrene-poly(ethylene-propylene) (“S-EP-S-EP”) block copolymer.

Examples of elastomeric polyolefins include ultra-low density elastomeric polypropylenes and polyethylenes, such as those produced by “single-site” or “metallocene” catalysis methods. Such elastomeric olefin polymers are commercially available from ExxonMobil Chemical Co. of Houston, Tex. under the trade designations ACHIEVE® (propylene-based), EXACT® (ethylene-based), and EXCEED® (ethylene-based). Elastomeric olefin polymers are also commercially available from DuPont Dow Elastomers, LLC (a joint venture between DuPont and the Dow Chemical Co.) under the trade designation ENGAGE®) (ethylene-based) and from Dow Chemical Co. of Midland, Mich, under the name AFFINITY® (ethylene-based). Examples of such polymers are also described in U.S. Pat. Nos. 5,278,272 and 5,272,236 to Lai, et al., which are incorporated herein in their entirety by reference thereto for all purposes. Also useful are certain elastomeric polypropylenes, such as described in U.S. Pat. No. 5,539,056 to Yang, et al. and U.S. Pat. No. 5,596,052 to Resconi, et al., which are incorporated herein in their entirety by reference thereto for all purposes.

If desired, the fibers of the first nonwoven layer may also contain an opacifying agent that enhances the opacity of the layer. For example, the first nonwoven layer may have a percent opacity of about 20% or more, in some embodiments, about 30% or more, and in some embodiments, from about 35% to about 70%. The percent opacity of the nonwoven layer may be measured as is known in the art using a HunterLab Color Difference Meter, Model DP 9000 in accordance with ASTM E1347 (“Standard Test Method for Color and Color-Difference Measurement by Tristimulus (Filter) Colorimetry”). The test is based on a percentage of light which passes through the sample. For example, when no light passes through the sample, the sample will have 100% opacity. Conversely, 0% opacity corresponds to a transparent sample.

Suitable opacifying agents for use in the first layer may include inorganic particles, such as silica, alumina, zirconia, magnesium oxide, titanium dioxide, iron oxide, zinc oxide, zeolites, silicates, titanates, zirconates, clays (e.g., smectite or bentonite), calcium carbonate, and barium sulfate; organic particles, e.g., carbon black and organic pigments; and so forth. The particles may possess various forms, shapes, and sizes depending upon the desired result, such as a sphere, crystal, rod, disk, tube, string, etc. The average size of the particles may be less than about 500 micrometers, in some embodiments from about 0.5 to about 100 micrometers, in some embodiments from about 1 to about 50 micrometers, and in some embodiments, from about 2 to about 40 micrometers.

If desired, the opacifying agent may be blended with a carrier resin to form a masterbatch. Among other things, the carrier resin enhances the compatibility of the opacifying agent with the base composition used to form the nonwoven web. Exemplary polymers for use in the carrier resin may include, for instance, high and low density polyethylene, polypropylene, polyoxymethylene, poly(vinylidine fluoride), poly(methyl pentene), poly(ethylene-chlorotrifluoroethylene), poly(vinyl fluoride), and polybutene. Particularly desired polymers are predominantly linear polymers having a regular structure. Examples of semi-crystalline, linear polymers that may be used in the present invention include polyethylene, polypropylene, blends of such polymers and copolymers of such polymers. The amount of the carrier resin employed will generally depend on a variety of factors, such as the type of carrier resin and base composition, the type of particles, the processing conditions, etc.

The carrier resin may be blended with the opacifying agent using any known technique, such as batch and/or continuous compounding techniques that employ, for example, a Banbury mixer, Farrel continuous mixer, single screw extruder, twin screw extruder, etc. If desired, the carrier resin and opacifying agent may be dry blended. After blending, the masterbatch may be processed immediately or pelletized for subsequent use. For example, the blend may be extruded into a water bath and cut into pellet form using a knife or other suitable cutting surface. Typically, the carrier resin constitutes from about 20 wt. % to about 80 wt. %, in some embodiments from about 30 wt. % to about 70 wt. %, and in some embodiments, from about 40 wt. % to about 60 wt. % of the masterbatch. The opacifying agent likewise normally constitutes from about 20 wt. % to about 80 wt. %, in some embodiments from about 30 wt. % to about 70 wt. %, and in some embodiments, from about 40 wt. % to about 60 wt. % of the masterbatch.

Regardless of the particular form of the masterbatch, it is ultimately blended with the base polymer composition (e.g., polypropylene) when it is desired to form the nonwoven web. Due to the presence of the carrier resin, the masterbatch may be miscible with the base composition. If the compositions are immiscible, they may simply be blended under shear or modified to improve their interfacial properties. The masterbatch may be blended with the base composition before melt extrusion or within the extrusion apparatus itself. The opacifying agent may constitute from about 0.1 wt. % to about 20 wt. %, in some embodiments from about 0.5 wt. % to about 10 wt. %, and in some embodiments, from about 1 wt. % to about 5 wt. % of the blend. The base melt-extrudable polymer may constitute from about 70 wt. % to about 99.9 wt. %, in some embodiments from about 80 wt. % to about 99.5 wt. %, and in some embodiments, from about 85 wt. % to about 98 wt. % of the blend. When employed, the carrier resin for the opacifying agent may also constitute from about 0.1 wt. % to about 20 wt. %, in some embodiments from about 0.5 wt. % to about 10 wt. %, and in some embodiments, from about 1 wt. % to about 5 wt. % of the blend.

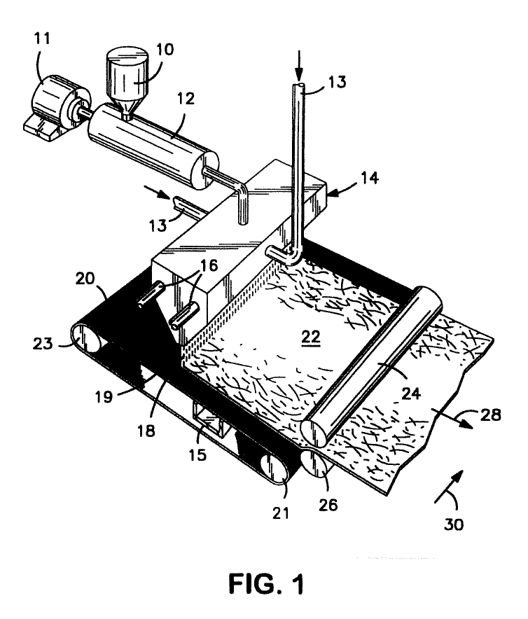

Any of a variety of processes may be used to form the first nonwoven layer. Referring to FIG. 1, for example, one embodiment of a method for forming a meltblown web is shown. Meltblown webs have a small average pore size, which may be used to inhibit the passage of liquids and particles, while allowing gases (e.g., air and water vapor) to pass therethrough. To achieve the desired pore size, the meltblown fibers are typically “microfibers” in that they have an average size of 10 micrometers or less, in some embodiments about 7 micrometers or less, and in some embodiments, about 5 micrometers or less. The ability to produce such fine fibers may be facilitated in the present invention through the use of a thermoplastic composition having the desirable combination of low apparent viscosity and high melt flow rate.

In FIG. 1, for instance, the raw materials (e.g., polymer, opacifying agent, carrier resin, etc.) are fed into an extruder 12 from a hopper 10. The raw materials may be provided to the hopper 10 using any conventional technique and in any state. The extruder 12 is driven by a motor 11 and heated to a temperature sufficient to extrude the melted polymer. For example, the extruder 12 may employ one or multiple zones operating at a temperature of from about 50° C. to about 500° C., in some embodiments, from about 100° C. to about 400° C., and in some embodiments, from about 150° C. to about 250° C. Typical shear rates range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. If desired, the extruder may also possess one or more zones that remove excess moisture from the polymer, such as vacuum zones, etc. The extruder may also be vented to allow volatile gases to escape.

Once formed, the thermoplastic composition may be subsequently fed to another extruder in a fiber formation line (e.g., extruder 12 of a meltblown spinning line). Alternatively, the thermoplastic composition may be directly formed into a fiber through supply to a die 14, which may be heated by a heater 16. It should be understood that other meltblown die tips may also be employed. As the polymer exits the die 14 at an orifice 19, high pressure fluid (e.g., heated air) supplied by conduits 13 attenuates and spreads the polymer stream into microfibers 18.

The microfibers 18 are randomly deposited onto a foraminous surface 20 (driven by rolls 21 and 23) with the aid of an optional suction box 15 to form a meltblown web 22. The distance between the die tip and the foraminous surface 20 is generally small to improve the uniformity of the fiber laydown. For example, the distance may be from about 1 to about 35 centimeters, and in some embodiments, from about 2.5 to about 15 centimeters. In FIG. 1, the direction of the arrow 28 shows the direction in which the web is formed (i.e., “machine direction”) and arrow 30 shows a direction perpendicular to the machine direction (i.e., “cross-machine direction”). Optionally, the meltblown web 22 may then be compressed by rolls 24 and 26. The desired denier of the fibers may vary depending on the desired application. Typically, the fibers are formed to have a denier per filament (i.e., the unit of linear density equal to the mass in grams per 9000 meters of fiber) of less than about 6, in some embodiments less than about 3, and in some embodiments, from about 0.5 to about 3. In addition, the fibers generally have an average diameter of from about 0.1 to about 20 micrometers, in some embodiments from about 0.5 to about 15 micrometers, and in some embodiments, from about 1 to about 10 micrometers.

Once formed, the nonwoven web may then be bonded using any conventional technique, such as with an adhesive or autogenously (e.g., fusion and/or self-adhesion of the fibers without an applied external adhesive). Autogenous bonding, for instance, may be achieved through contact of the fibers while they are semi-molten or tacky, or simply by blending a tackifying resin and/or solvent with the polymers used to form the fibers. Suitable autogenous bonding techniques may include ultrasonic bonding, thermal bonding, through-air bonding, calendar bonding, and so forth. For example, the web may be further bonded or embossed with a pattern by a thermo-mechanical process in which the web is passed between a heated smooth anvil roll and a heated pattern roll. The pattern roll may have any raised pattern which provides the desired web properties or appearance. Desirably, the pattern roll defines a raised pattern which defines a plurality of bond locations which define a bond area between about 2% and 30% of the total area of the roll. Exemplary bond patterns include, for instance, those described in U.S. Pat. No. 3,855,046 to Hansen et al., U.S. Pat. No. 5,620,779 to Levy et al., U.S. Pat. No. 5,962,112 to Haynes et al., U.S. Pat. No. 6,093,665 to Sayovitz et al., as well as U.S. Design Pat. No. 428,267 to Romano et al.; U.S. Design Pat. No. 390,708 to Brown; U.S. Design Pat. No. 418,305 to Zander, et al.; U.S. Design Pat. No. 384,508 to Zander, et al.; U.S. Design Pat. No. 384,819 to Zander, et al.; U.S. Design Pat. No. 358,035 to Zander, et al.; and U.S. Design Pat. No. 315,990 to Blenke, et al., all of which are incorporated herein in their entirety by reference thereto for all purposes. The pressure between the rolls may be from about 5 to about 2000 pounds per lineal inch. The pressure between the rolls and the temperature of the rolls is balanced to obtain desired web properties or appearance while maintaining cloth like properties. As is well known to those skilled in the art, the temperature and pressure required may vary depending upon many factors including but not limited to, pattern bond area, polymer properties, fiber properties and nonwoven properties.

In addition to meltblown webs, a variety of other nonwoven webs may also be formed from the thermoplastic composition in accordance with the present invention, such as spunbond webs, bonded carded webs, etc. For example, the polymer may be extruded through a spinnerette, quenched and drawn into substantially continuous filaments, and randomly deposited onto a forming surface. Alternatively, the polymer may be formed into a carded web by placing bales of fibers formed from the thermoplastic composition into a picker that separates the fibers. Next, the fibers are sent through a combing or carding unit that further breaks apart and aligns the fibers in the machine direction so as to form a machine direction-oriented fibrous nonwoven web. Once formed, the nonwoven web is typically stabilized by one or more known bonding techniques.

If desired, the nonwoven web may also be a composite that contains a combination of the thermoplastic composition fibers and other types of fibers (e.g., staple fibers, filaments, etc). For example, additional synthetic fibers may be utilized, such as those formed from polyolefins, e.g., polyethylene, polypropylene, polybutylene, and so forth.

### II. Second Nonwoven Layer

The second nonwoven layer may be formed in any manner known in the art and as described above. For example, in certain embodiments, the second nonwoven layer may be a meltblown web, spunbond web, etc. Regardless of the manner in which it is formed, a colorant (e.g., dye, pigment, etc.) is incorporated into the second layer for imparting some perceivable difference in color between the first and second nonwoven layers. Possible colors that contrast well with a first nonwoven layer that is white, for instance, include yellow, cyan, magenta, red, green, blue, orange, black, etc. The relative degree of contrast between the colors of each layer may be measured through a gray-level difference value. In a particular embodiment, the contrast may have a gray level value of about 45 on a scale of 0 to about 255, where 0 represents “black” and 255 represents “white.” The analysis method may be made with a Quantimet 600 Image Analysis System (Leica, Inc., Cambridge, UK). This system's software (QWIN Version 1.06A) enables a program to be used in the Quantimet User Interactive Programming System (QUIPS) to make the gray-level determinations. A control or “blank” white-level may be set using undeveloped Polaroid photographic film. An 8-bit gray-level scale may then be used (0-255) and the program allowed the light level to be set by using the photographic film as the standard. A region containing the other color (e.g., background or foreground) may then be measured for its gray-level value, followed by the same measurement of the activate carbon ink. The routine may be programmed to automatically calculate the gray-level value of the activated carbon ink. The difference in gray-level value between the first and second nonwoven layers may be about 45 or greater on a scale of 0-255, where 0 represents “black” and 255 represents “white.”

Suitable colorants may for use in the second layer may include those dyes approved for use in foods, drugs, cosmetics (FD&C colors), drugs and cosmetics only (D&C colors), or only in topically applied drugs and cosmetics (external D&C colors). Examples of such dyes include FD&C Blue 2, FD & C Blue No 11, FD & C Blue No 12, FD &C Green No 13, FD & C Red No 13, FD & C Red No 140, FD&C Yellow No. 15, FD&C Yellow No. 16, D&C Blue No. 14, D&C Blue No. 19, D&C Green No. 15, D&C Green No. 16, D&C Green No. 18, D&C Orange No. 5, D&C Orange No. 14, D&C Orange No. 15, D&C Orange No. 110, D&C Orange No. 111, D&C Orange No. 117, FD&C Red No. 14, D&C Red No. 16, D&C Red No. 17, D&C Red No. 18, D&C Red No. 19, D&C Red No. 27, D&C Red No. 117, D&C Red No. 119, D&C Red No. 121, D&C Red No. 122, D&C Red No. 127, D&C Red No. 128, D&C Red No. 130, D&C Red No. 131, D&C Red No. 134, D&C Red No. 139, FD&C Red No. 140, D&C Violet No. 2, D&C Violet No. 12, D&C Yellow No. 17, D&C Yellow No. 18, D&C Yellow No. 111, D&C Brown No. 11, D&C Blue No. 16 and D&C Yellow No. 110. Other suitable dyes are described in 21 C.F.R. Part 74 and the CTFA Cosmetic Ingredient Handbook, published by the Cosmetics, Toiletry and Fragrancy Association, Inc. Still other suitable colorants include any organic and/or inorganic pigments, such as D&C Red 7, calcium lake, D&C Red 30, talc Lake, D&C Red 6, barium lake, Russet iron oxide, yellow iron oxide, brown iron oxide, talc, kaolin, mica, mica titanium, red iron oxide, magnesium silicate and titanium oxide; and organic pigment such as Red No 202, Red No 204, Red No 205, Red No 206, Red No 219, Red No 228, Red No 404, Yellow No 205, Yellow No 401, Orange No 401 and Blue No 404. Examples of oil soluble dyes include Red No 505, Red No 501, Red No 225, Yellow No 404, Yellow No 405, Yellow No 204, Orange No 403, Blue No 403, Green No 202 and Purple No 201. Examples of lake dye include various acid dyes which are laked with aluminum, calcium or barium.

The colorant may be incorporated into the polymer composition used to form the fibers of the second layer, or it may simply be applied to all or only a portion of a surface of the second layer. Any technique may be employed to apply the colorant to a surface of the nonwoven layer, such as printing, dipping, spraying, melt extruding, coating (e.g., solvent coating, powder coating, brush coating, etc.), spraying, and so forth. In one embodiment, for example, the colorant is printed onto the layer in the form of an ink. A variety of printing techniques may be used for applying the ink to the layer, such as gravure printing, flexographic printing, screen printing, laser printing, thermal ribbon printing, piston printing, etc. In one particular embodiment, ink-jet printing techniques are employed to apply the ink to the nonwoven layer. Ink-jet printing is a non-contact printing technique that involves forcing an ink through a tiny nozzle (or a series of nozzles) to form droplets that are directed toward the support. Two techniques are generally utilized, i.e., “DOD” (Drop-On-Demand) or “continuous” ink-jet printing. In continuous systems, ink is emitted in a continuous stream under pressure through at least one orifice or nozzle. The stream is perturbed by a pressurization actuator to break the stream into droplets at a fixed distance from the orifice. DOD systems, on the other hand, use a pressurization actuator at each orifice to break the ink into droplets. The pressurization actuator in each system may be a piezoelectric crystal, an acoustic device, a thermal device, etc. The selection of the type of ink jet system varies on the type of material to be printed from the print head. For example, conductive materials are sometimes required for continuous systems because the droplets are deflected electrostatically.

Prior to application, the colorant is typically dissolved or dispersed in a solvent to form an ink. Any solvent capable of dispersing or dissolving the components is suitable, for example water; alcohols such as ethanol or methanol; dimethylformamide; dimethyl sulfoxide; hydrocarbons such as pentane, butane, heptane, hexane, toluene and xylene; ethers such as diethyl ether and tetrahydrofuran; ketones and aldehydes such as acetone and methyl ethyl ketone; acids such as acetic acid and formic acid; and halogenated solvents such as dichloromethane and carbon tetrachloride; as well as mixtures thereof. The concentration of solvent in the ink formulation is generally high enough to allow easy application, handling, etc. If the amount of solvent is too large, however, the amount of activated carbon deposited on the substrate might be too low to provide the desired odor reduction. Although the actual concentration of solvent employed will generally depend on the type of activated carbon and the substrate on which it is applied, it is nonetheless typically present in an amount from about 40 wt. % to about 99 wt. %, in some embodiments from about 50 wt. % to about 95 wt. %, and in some embodiments, from about 60 wt. % to about 90 wt. % of the ink (prior to drying). The colorant may likewise constitute from about 0.01 to about 20 wt. %, in some embodiments from about 0.01 wt. % to about 10 wt. %, in some embodiments, from about 0.05 wt. % to about 5 wt. %, and in some embodiments, from about 0.1 wt. % to about 3 wt. % of the ink (prior to drying).

Besides the colorant, the ink may also include various other components as is well known in the art, such as colorant stabilizers, photoinitiators, binders, solvents, surfactants, humectants, biocides or biostats, electrolytic salts, pH adjusters, etc. For example, examples of such humectants include, but are not limited to, ethylene glycol; diethylene glycol; glycerine; polyethylene glycol 200, 400, and 600; propane 1,3 diol; propylene-glycolmonomethyl ethers, such as Dowanol PM (Gallade Chemical Inc., Santa Ana, Calif.); polyhydric alcohols; or combinations thereof. Other additives may also be included to improve ink performance, such as a chelating agent to sequester metal ions that could become involved in chemical reactions over time, a corrosion inhibitor to help protect metal components of the printer or ink delivery system, a biocide or biostat to control unwanted bacterial, fungal, or yeast growth in the ink, and a surfactant to adjust the ink surface tension. Other components for use in an ink are described in U.S. Pat. No. 5,681,380 to Nohr, et al. and U.S. Pat. No. 6,542,379 to Nohr, et al., which are incorporated herein in their entirety by reference thereto for all purposes.

### III. Wipe Construction

The wipe of the present invention is a laminate that includes the first nonwoven layer positioned adjacent to the second nonwoven layer and bonded together using any conventional technique, such as the adhesive or autogenous bonding techniques described above. In one embodiment, for example, the laminate passes through a nip formed between a pair of rolls, one or both of which are heated to melt-fuse the fibers. One or both of the rolls may also contain intermittently raised bond points to provide an intermittent bonding pattern. The pattern of the raised points is generally selected so that the nonwoven laminate has a total bond area of less than about 50% (as determined by conventional optical microscopic methods), and in some embodiments, less than about 30%. Likewise, the bond density is also typically greater than about 100 bonds per square inch, and in some embodiments, from about 250 to about 500 pin bonds per square inch. The bonding temperature (e.g., the temperature of the rollers) may be relatively low, such as from about 60° C. to about 250° C., in some embodiments from about 100° C. to about 200° C., and in some embodiments, from about 120° C. to about 180° C. Likewise, the nip pressure may range from about 1 to about 50 pounds per square inch, in some embodiments, from about 2 to about 40 pounds per square inch, and in some embodiments, from about 5 to about 20 pounds per square inch.

The resulting wipe typically has a basis weight of from about 20 to about 200 grams per square meter (gsm), in some embodiments from about 30 to about 150 gsm, and in some embodiments, from about 40 to about 100 gsm. Further, the wipe may assume a variety of shapes, including but not limited to, generally circular, oval, square, rectangular, or irregularly shaped. Each individual wipe may be arranged in a folded configuration and stacked one on top of the other to provide a stack of wet wipes. Such folded configurations are well known to those skilled in the art and include c-folded, z-folded, quarter-folded configurations and so forth. For example, the wipe may have an unfolded length of from about 2.0 to about 80.0 centimeters, and in some embodiments, from about 10.0 to about 25.0 centimeters. The wipes may likewise have an unfolded width of from about 2.0 to about 80.0 centimeters, and in some embodiments, from about 10.0 to about 25.0 centimeters. The stack of folded wipes may be placed in the interior of a container, such as a plastic tub, to provide a package of wipes for eventual sale to the consumer. Alternatively, the wipes may include a continuous strip of material which has perforations between each wipe and which may be arranged in a stack or wound into a roll for dispensing. Various suitable dispensers, containers, and systems for delivering wipes are described in U.S. Pat. No. 5,785,179 to Buczwinski, et al.; U.S. Pat. No. 5,964,351 to Zander; U.S. Pat. No. 6,030,331 to Zander; U.S. Pat. No. 6,158,614 to Haynes, et al.; U.S. Pat. No. 6,269,969 to Huang, et al.; U.S. Pat. No. 6,269,970 to Huang, et al.; and U.S. Pat. No. 6,273,359 to Newman, et al., which are incorporated herein in their entirety by reference thereto for all purposes.

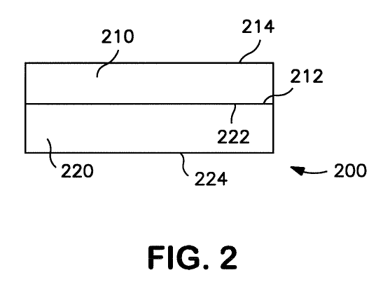

Referring to FIG. 2, one particular embodiment of a cosmetic wipe 200 is shown that includes a first nonwoven layer 210 having a first surface 212 and a second opposing surface 214. The cosmetic wipe 200 also includes a second nonwoven layer 220 having a third surface 222 and a fourth opposing surface 224. In this particular embodiment, the third surface 222 of the nonwoven layer 220 is laminated to the first surface 212 of the nonwoven layer 210. With this particular construction, the second surface 214 and fourth surface 224 define external surfaces of the wipe 200 for contacting skin. It should of course be understood that the wipe 200 may also include additional layers, so long as the first and second nonwoven layers 210 and 220 are positioned adjacent to each other. Prior to use, the second layer 220 is not generally visible when the wipe 200 is viewed from the second surface 214. However, the absorption of oil by the first layer 210 causes at least a portion of the layer 210 to become translucent or transparent so that the color of the second layer 220 becomes visible. For example, the portion of the layer 210 that contacts the bodily oil may have a percent opacity of about 60% or less, in some embodiments, about 40% or less, and in some embodiments, from 1% to about 20%. This change in opacity occurs rapidly, such as about 30 seconds or less, in some embodiments about 15 seconds or less, and in some embodiments, about 5 seconds or less. In this manner, the cosmetic wipe of the present invention is capable of providing a user with the real-time ability to determine if or how much sebum was removed from the skin.

The present invention may be better understood with reference to the following examples.

### EXAMPLE 1

A 35 gsm meltblown web was sprayed with 0.1% wt/wt Drug & Cosmetic (D&C) Violet 2 dye (Noveon Inc., Cincinnati, Ohio) in isopropanol solution using a Prevail sprayer (Precision Valve Corporation, Yonkers, N.Y.). The light coating was allowed to air dry in a fumehood for 1 hour. The colored fabric was then heat compressed with a 20 gsm white meltblown web at about 10 psi for 50 seconds with a temperature ranging between 315° F. to 320° F. The resultant laminate was colored on one side and white on the other. The fabric was then cut into 5 cm×20 cm strips and wiped on volunteer human faces around the top of the nose. The white fabric side when contacted with human oil turned transparent to reveal the vivid color of the opposite side, giving the impression that the fabric had turned color on contact with the facial oil. When the colored side was used the pastel colored fabric turned a deeper color when contacted with the facial oil.

### EXAMPLE 2

A 30 gsm meltblown web with 1% blue pigment was heat embossed (checkered pattern) with a 20 gsm white meltblown web with pressure ranging between about 5 to 10 psi for 20 to 40 seconds at 230° F. The white fabric side when contacted with human oil, which turned the white fabric transparent and revealed the vivid color of the opposite side to give the impression that the fabric had turned color on contact with the facial oil. When the colored side was used, the pastel colored fabric turned a deeper color when contacted with the facial oil.

### EXAMPLE 3

A 20 gsm meltblown web with 1% blue pigment was heat compressed at 20 psi for 20 seconds at 230° F., and then compressed with a 20 gsm white meltblown web at 10 psi for 30 seconds at 230° F. The white fabric side when contacted with human oil, which turned the white fabric transparent and revealed the vivid color of the opposite side to give the impression that the fabric had turned color on contact with the facial oil. When the colored side was used, the pastel colored fabric turned a deeper color when contacted with the facial oil.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A cosmetic wipe comprising:
a first nonwoven layer that is generally opaque; and
a second nonwoven layer laminated to the first nonwoven layer, the second nonwoven layer including a colorant that provides the second layer with a color that is visually distinguishable from the color of the first nonwoven layer;
wherein at least a portion of the first nonwoven layer is configured to undergo a change in opacity upon the absorption of a bodily oil so that the portion is translucent or transparent to light, the color of the second nonwoven layer being visible through the translucent or transparent portion.

2. The cosmetic wipe of claim 1, wherein the first nonwoven layer includes a meltblown web.

3. The cosmetic wipe of claim 2, wherein the first nonwoven layer includes a spunbond web.

4. The cosmetic wipe of claim 1, wherein the first nonwoven layer includes a polyolefin.

5. The cosmetic wipe of claim 1, wherein the first nonwoven layer includes an opacifying agent.

6. The cosmetic wipe of claim 5, wherein the opacifying agent include titanium dioxide particles.

7. The cosmetic wipe of claim 1, wherein the first nonwoven layer has a percent opacity of about 20% or more.

8. The cosmetic wipe of claim 1, wherein the first nonwoven layer has a percent opacity of about 35% to about 70%.

9. The cosmetic wipe of claim 1, wherein the second nonwoven layer includes a meltblown web.

10. The cosmetic wipe of claim 9, wherein the second nonwoven layer includes a spunbond web.

11. The cosmetic wipe of claim 1, wherein the second nonwoven layer includes a polyolefin.

12. The cosmetic wipe of claim 1, wherein the colorant is a dye.

13. The cosmetic wipe of claim 1, wherein the contrast between the color presented by the first nonwoven layer and the color presented by the second nonwoven layer has a minimum gray scale value of about 45 or more on a scale of 0-255.

14. The cosmetic wipe of claim 1, wherein the color presented by the first nonwoven layer is white and the color presented by the second nonwoven layer is yellow, cyan, magenta, red, green, blue, black, orange, or a combination thereof.

15. The cosmetic wipe of claim 1, wherein the first nonwoven layer has a first surface and a second opposing surface and the second nonwoven layer has a third surface and a fourth opposing surface, the first surface being positioned adjacent to the third surface.

16. The cosmetic wipe of claim 15, wherein the colorant is applied to the first surface of the first nonwoven layer.

17. The cosmetic wipe of claim 15, wherein the second surface of the first nonwoven layer and the fourth surface of the second nonwoven layer together define exterior surfaces of the wipe.

18. A method for assessing the effectiveness of a wipe in removing a bodily oil from the skin, the method comprising:
providing a wipe that includes a first nonwoven layer and a second nonwoven layer laminated to the first nonwoven layer, the second nonwoven layer presenting a color that is visually distinguishable from the color presented by the first nonwoven layer;
contacting the skin with the first nonwoven layer of the wipe so that at least a portion of the first nonwoven layer undergoes a change in opacity and becomes translucent or transparent to light; and
observing the color of the second nonwoven layer through the translucent or transparent portion of the first nonwoven layer.

19. The method of claim 18, wherein the first nonwoven layer, the second nonwoven layer, or both include a meltblown web.

20. The method of claim 18, wherein the first nonwoven layer, the second nonwoven layer, or both include a polyolefin.

21. The method of claim 18, wherein before contacting the skin with the first nonwoven layer of the wipe, the contrast between the color presented by the first nonwoven layer and the color presented by the second nonwoven layer has a minimum gray scale value of about 45 or more on a scale of 0-255.

22. The method of claim 18, wherein before contacting the skin with the first nonwoven layer of the wipe, the color presented by the first nonwoven layer is white and the color presented by the second nonwoven layer is yellow, cyan, magenta, red, green, blue, black, orange, or a combination thereof.

23. The method of claim 18, wherein the first nonwoven layer has a first surface and a second opposing surface and the second nonwoven layer has a third surface and a fourth opposing surface, the first surface being positioned adjacent to the third surface.

24. The method of claim 23, wherein the second surface of the first nonwoven layer and the fourth surface of the second nonwoven layer together define exterior surfaces of the wipe.

25. The method of claim 24, wherein the second surface of the first nonwoven layer is contacted with the skin.
